(19) United States
(12) Patent Application Publication
(10) Pub. No.: US 2026/0017396 A1
(43) Pub. Date: Jan. 15, 2026

(54) TIME-BASED CONFIGURATION ACCESS FOR NETWORK ACCESS STORAGE SECURITY

(71) Applicant: Dell Products L.P., Round Rock, TX (US)

(72) Inventors: Shiv S Kumar, Pune (IN); Kaushik Gupta, Pune (IN)

(21) Appl. No.: 18/769,690

(22) Filed: Jul. 11, 2024

(51) Int. Cl. G06F 21/62; G06F 9/54

(52) U.S. Cl. CPC G06F 21/6218; G06F 9/544

(57) ABSTRACT

Described is technology that facilitates control of configuration access to a control path of a network access storage system. An example system comprises at least one processor, and at least one memory that stores executable instructions that, when executed by the at least one processor, facilitate performance of operations, comprising determining a specified time window relative to an application programming interface (API) employed for configuration access to a control path of a storage system, and based on the specified time window, generating a schedule for the configuration access to the control path, wherein the schedule comprises an access-based time window defining allowable access by the API to the control path.

### BACKGROUND

Provision of configuration access to a network access storage system can comprise a complicated miasma of operations for a plurality of machines, clusters, and/or files of such network access storage system (e.g., NAS). As quantities of data continue to expand for uses of such data, an NAS can grow in size, accompanied by increased accesses by an increased number of user entities. Controlling such a scale of access to a control path of such NAS, at varying levels of granularity of control, can be desired.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

Described herein are one or more frameworks directed to providing control, using time-based configuration access control restrictions, for configuration access to an NAS. As used herein, configuration access refers to access to a control path (e.g., to a control side) of an NAS, as differentiated to a use path (e.g., as employed by typical user entities storing files, data, metadata, etc. at an NAS. The one or more frameworks can thereby provide for security of configuration access to the NAS (e.g., use related to reading, writing, deleting, modifying, moving, etc. of NAS functioning).

An example system can comprise at least one processor, and at least one memory that stores executable instructions that, when executed by the at least one processor, facilitate performance of operations, comprising determining a specified time window relative to an application programming interface (API) employed for configuration access to a control path of a storage system, and based on the specified time window, generating a schedule for the configuration access to the control path, wherein the schedule comprises an access-based time window defining allowable access by the API to the control path.

An example method, such as a computer-implemented method, can comprise accessing, by a system comprising at least one processor, a data store comprising access data bounding configuration access by plural user entities using plural application programming interfaces (APIs) for the configuration access to a control path of a storage system, determining that an entry associated with an API, of the plural APIs, and a user entity, of the plural user entities, exists in the data store, reading the entry, and determining whether to allow an access of the user entity, by the API, to the control path, depending on whether a timing of the access is within an access-based time restriction comprised by the entry.

An example benefit of one or more of the above-indicated method, system and/or non-transitory computer-readable medium can be an ability to provide a level of configuration access control that cannot be provided by existing frameworks. This configuration access control can comprise use of plural access-based time windows for a same API or user entity requesting configuration access, use of different access-based time windows for different APIs, user entities and/or combinations thereof, and/or use of different access-based time windows for different request types being sought relative to an API and/or user entity.

Further, this control of privileges of access to an NAS control path, relative to APIs and/or user entities, can be provided in scale. For example, configuration access to plural, even hundreds or more machines in a cluster of an NAS can be controlled using the one or more embodiments described herein. Such control can be provided for one or more control paths corresponding to plural NASs and/or plural clusters (of a same or different NASs) at least partially at a same time as one another. In one or more embodiments, generation of a control schedule can be provided at least partially at a same time as use of the control schedule. In one or more embodiments, generation of plural control schedules can be provided at least partially at a same time as one another. In one or more embodiments, use of plural control schedules can be provided at least partially at a same time as one another.

Another example benefit of one or more of the above-indicated method, system and/or non-transitory computer-readable medium can be an ability to provide supervisory control of the configuration access control. That is, provision access (e.g., access related to provision of parameters, guidelines, metes and/or bounds for defining one or more configuration access controls) can be controlled by the one or more frameworks described herein. This provision access can be self-resolving, such as in instances of overlapping and/or conflicting configuration access control entries. In one or more cases, resolution can be a function of authentication level (e.g., administrator entity security level) corresponding to a configuration access control restriction (or related configuration access parameter on which the configuration access control restriction is based). Additionally, and/or alternatively, in one or more cases, resolution can be a function of a time of entry of the configuration access control restriction (or related configuration access parameter on which the configuration access control restriction is based).

Still another example benefit of one or more of the above-indicated method, system and/or non-transitory computer-readable medium can be an ability to provide one or more of the above-noted benefits across varying types of network access storage systems (NASs) and/or corresponding control paths, thus allowing for the one or more embodiments described herein to be hardware, software and/or vendor agnostic relative to different NASs and/or control paths. In this way, a configuration access system described herein can be employed to control user entity access to an NAS control path, generally absent being dependent on a single product, service, device, vendor and/or platform of NASs and/or control paths being controlled and/or secured. In this way, it can be easier for an NAS service provider (NSP) to meet desired scale and/or deployment consistency requirements.

### BRIEF DESCRIPTION OF THE DRAWINGS

The technology described herein is illustrated by way of example and not limited to the accompanying figures in which like reference numerals indicate similar elements.

FIG. 1 illustrates a block diagram of an example, non-limiting system that can provide configuration access control of a control path corresponding to an NAS, and thus also use access control of an NAS, in accordance with one or more embodiments described herein.

FIG. 2 illustrates a block diagram of an example, network access storage system (NAS), in accordance with one or more embodiments described herein.

FIG. 3 illustrates a schematic diagram of an access data generation process for generating a schedule used for controlling configuration access to an NAS control path, in accordance with one or more embodiments described herein.

FIG. 4 illustrates a schematic diagram of a configuration access execution process for controlling configuration access to an NAS control path, in accordance with one or more embodiments described herein.

FIG. 5 illustrates a process flow diagram of a method of configuration access control of an NAS control path, in accordance with one or more embodiments and/or implementations described herein.

FIG. 6 illustrates a continuation of the process flow diagram of FIG. 5, in accordance with one or more embodiments and/or implementations described herein.

FIG. 7 illustrates a process flow diagram of a method of configuration access control of an NAS control path, in accordance with one or more embodiments and/or implementations described herein.

FIG. 8 illustrates a continuation of the process flow diagram of FIG. 7, in accordance with one or more embodiments and/or implementations described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part.

### DETAILED DESCRIPTION

### OVERVIEW

The technology described herein is generally directed towards systems, methods and/or computer program products for facilitating security of a control path of a network access storage system (NAS) by provided for control of configuration access to the control path.

As alluded to above, configuration access to a network access storage system can comprise a complicated miasma of operations for a plurality of machines, clusters, and/or files of such network access storage system (e.g., NAS). Complicating such configuration access is the security risk provided by existing configuration access control frameworks.

That is, cluster configuration application program interfaces (APIs), and other APIs providing configuration access to an NAS and/or control path of an NAS, are typically always active and ready to act upon receipt of a configuration access request. Often, even most critical and/or sensitive APIs are ready to serve all the time. This state of readiness can provide a wide window for intruders, bad acting entities and/or the like to use such APIs to access a control path of a network access control system.

In view of these deficiencies, it can therefore be desired to provide a framework for addressing this security risk. Accordingly, to account for one or more deficiencies of existing approaches, described herein are one or more embodiments that can employ various configuration access inputs to generate a schedule providing an infinite number of restriction types without being limited to a discrete set of access-based restrictions. Indeed, the one or more embodiments described herein are not limited to extreme restrictions such as always allowing access, never allowing access and/or the like. Further, access-based restrictions can be generated and employed for different combinations of configuration access control (CAC) parameters comprising, but not limited to, user entities (accessing the control path), APIs (used by the user entities to access the control path), API request types (e.g., PUT, POST, DELETE, GET), particular and/or type of configuration to be accessed, and/or time of access (e.g., time of a day, time of a week, and/or any other time-based restriction). For example, different combinations of any one or more of these CAC parameters can be employed to generate a CAC entry, with a plurality of entries being generated to bound a schedule for configuration access to an NAS (e.g., to a control path of an NAS).

Generally, a method for generating a configuration access schedule can comprise a plurality of one or more processes comprising, but not limited to, determining a specified time window for access, determining one or more other CAC parameters for access, generating a CAC entry, and/or generating a plurality of additional entries to define a schedule.

In one or more embodiments, such method for generating a configuration access schedule can comprise limiting writing, modifying, deleting and/or storing of access data corresponding to one or more CAC parameters, such as providing such limits as corresponding to one or more administrator entities having authority to access an information data store employed by the one or more embodiments described herein to generate the schedule. In one or more embodiments, such method for generating a configuration access schedule can comprise enabling overriding of data/metadata of the data store by a super administrator entity, where the data/metadata was added and/or modified by a lower-authority administrator entity.

Generally, a method for using a configuration access schedule to control configuration access to an NAS control path can comprise a plurality of one or more processes comprising, but not limited to, obtaining an configuration access request, determining a user entity and/or API associated with the configuration access request, determining an requested access time, determining one or more CAC entries associated with the gathered information, comparing the gathered information to the one or more CAC entries, determining if the gathered information matches or does not match the one or more CAC entries, generating a notification that access has been denied if the gathered information does not match the one or more CAC entries, and/or spawning a thread to execute the configuration access request if the gathered information matches the one or more CAC entries.

In one or more embodiments, the one or more frameworks described herein can be implemented as a plug-and-play process without being limited by structure, software, hardware, firmware, etc. of a network access storage system (NAS) and/or associated control path. That is, the one or more frameworks described herein can be hardware, software and/or vendor agnostic relative to different NASs and/or control paths.

### TERMINOLOGY

As used herein, the terms “cost” or “expense” can refer to power, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human. A “client entity” can refer to a client that stores and accesses data/metadata at a network access storage system. A “user entity,” as use herein, can refer to a user of a control path of a network access storage system, such as for access to configurations of the NAS (e.g., for controlling use access by one or more client entities). An “administrator entity” can refer to an entity having permission for provision access to thereby provide information used by the one or more embodiments described herein to bound the configuration access by the user entities.

As used herein, the term “group” can refer to one or more.

A “group of hardware” or “equipment” can refer to a subset of hardware devices of an operation system, which hardware devices can comprise, but are not limited to, storage nodes, switch nodes, server nodes and/or corresponding communication devices, and which operation system can comprise one or more computing systems.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, CPU bandwidth, processing power, labor, hardware and/or software.

As used herein, the term “set” can refer to one or more.

### EXAMPLE ARCHITECTURES

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

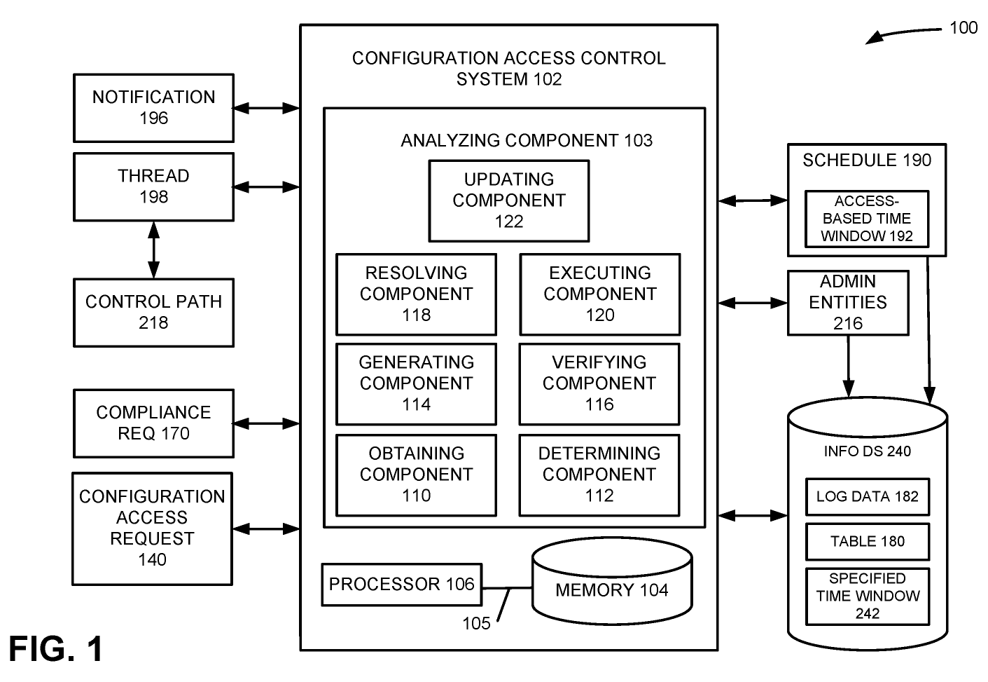

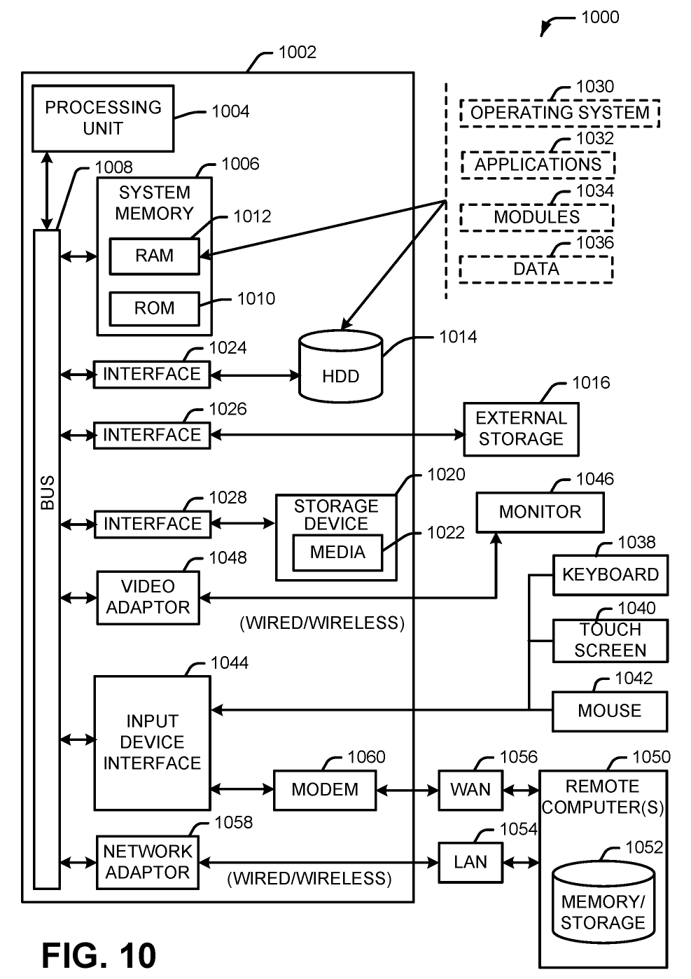

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIGS. 1-9 and/or with other figures described herein.

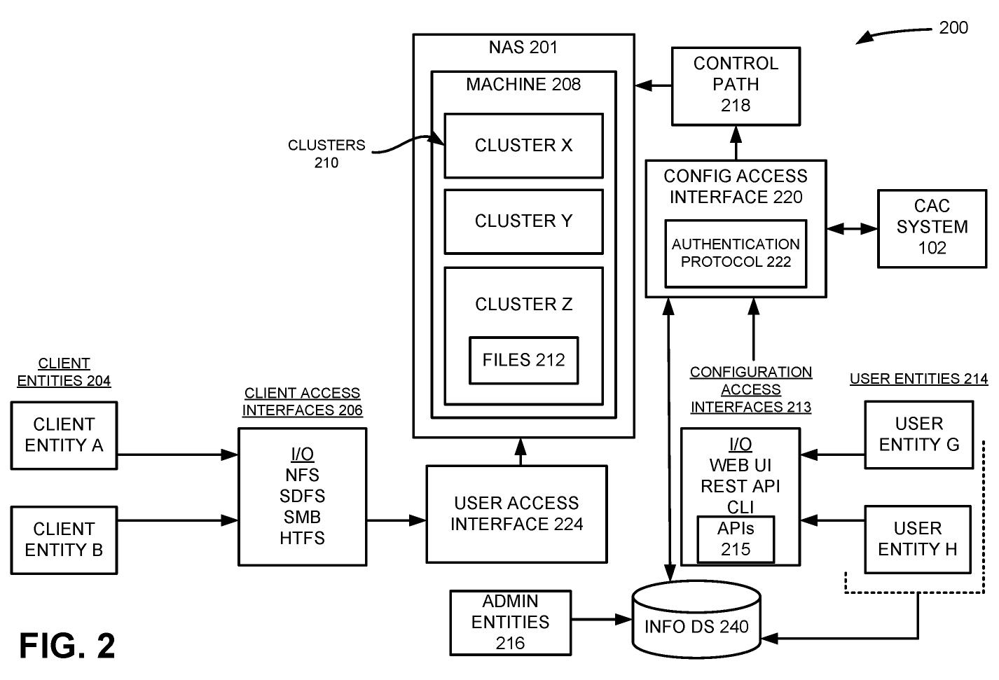

Turning now in particular to one or more figures, and first to FIG. 2, illustrated is an architecture 200 comprising a network access storage system (NAS) 201 and various interfaces and accessing entities of the NAS 201. The NAS 201 can comprise one or more machines 208, each comprising one or more clusters 210 (e.g., clusters X, Y, Z). Each cluster 210 can comprise a plurality of files 212, such as hundreds or even thousands of files 212. Accordingly, an NAS 201 can be a repository of millions or even billions of files for which different configuration access can be relevant.

Use access of an NAS 201 can be by way of client entities 204 (e.g., client entities A and B) employing a suitable computing device for accessing a client access interface 206. Use access can refer to the reading, writing, storing, modifying, copying, etc. of files 212 of an NAS 201. Differently, configuration access can refer to access providing control of configurations, parameters, functioning, etc. of an NAS 201, thereby controlling how the use access is facilitated.

Relative to use access, a client access interface 206 can comprise various protocols, application programming interfaces (APIs), etc. for facilitating use access to the NAS 201. This can comprise, but is not limited to NFS, SDFS, SMB and/or HTFS protocols. A user access interface 224 can be employed to provide authorization upon receipt of a use request for access to the NAS 201 by the client access interfaces 206.

Similarly, configuration access can comprise use of a configuration access interface 213 by user entities 214 (e.g., user entities G, H). A configuration access interface can comprise various protocols, APIs, applications, etc. for facilitating configuration access to the NAS 201. This can comprise, but is not limited to, WEB UI, Rest API and/or CLI. These options can comprise various APIs 215. The configuration access interfaces 213 can send a request for configuration access, of the NAS 201, to a configuration access interface 220. In one or more embodiments, the configuration access interface 220 can be communicatively coupled to a system of one or more embodiments described herein, such as to a configuration access control system 102, to be described next, below. In one or more embodiments, the configuration access interface 220 can provide user entity authentication using a suitable authentication protocol 222. In existing systems, the configuration access interface 220 can allow access to the NAS 201, such as via a control path 218, upon successful execution of the authentication protocol 222. This can allow for ease of access to bad actor entities, intruder entities, etc.

Differently, the one or more embodiments described herein (e.g., CAC system 102) can employ one or more additional verification protocols based on a schedule 190 comprising various access-based time windows 192 for limiting, allowing, disallowing and/or controlling configuration access by a user entity 214 (e.g., by way of an API 215) to the control path 218.

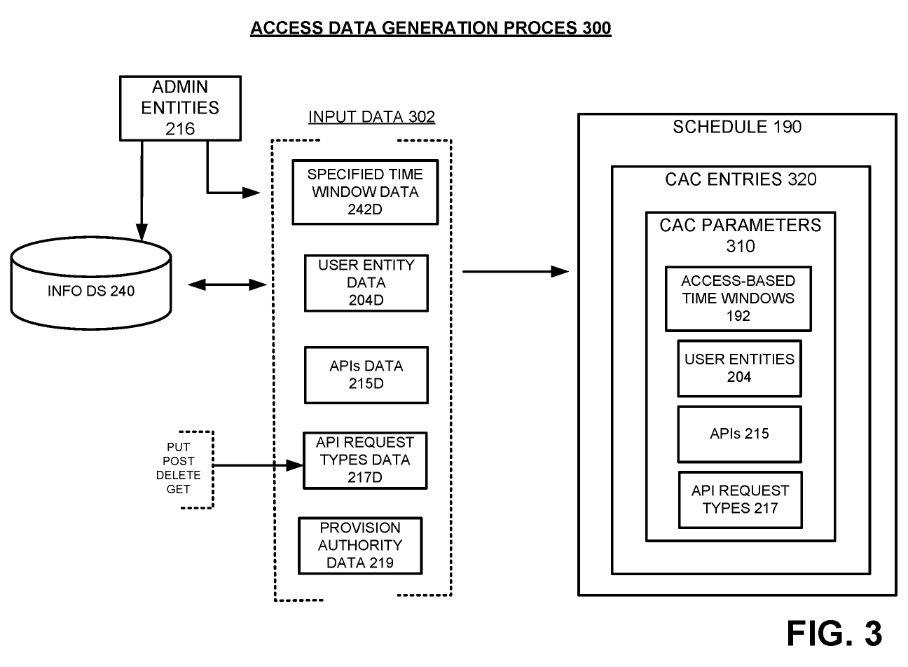

For example, as briefly and generally illustrated at FIG. 2, a CAC system 102 can employ an information data store 240 comprising access data, such as a schedule 190 and/or input data 302 (FIG. 3) to verify that a requested configuration access is able to be allowed, according to one or more CAC entries 320, of a schedule 190, providing corresponding CAC restrictions. In one or more embodiments, a schedule 190 can be in the form of a matrix, list, log, table 180 and/or any other suitable format comprising data and/or metadata.

Relative to the non-limiting system 100 of FIG. 1 and/or the architecture 200 of FIG. 2, the information data store 240 can be internal to and/or external to such frameworks, but allowing for communicative access by the configuration access interface 220 and/or CAC system 102.

Turning next to FIG. 1, the figure illustrates a block diagram of an example, non-limiting system 100 that can facilitate control of configuration access to an NAS control path 218. In one or more embodiments, the control path 218 can be referred to as comprising the configuration access interface 220, and/or can be separate therefrom. The control path 218 can comprise any suitable hardware, firmware, software, etc.

FIG. 1 illustrates the non-limiting system 100 comprising a configuration access control system (CAS system) 102 that can function provide both the control of the configuration access and the generation of a schedule 190 guiding the configuration access.

Generally, the configuration access control system 102 can comprise any suitable computing devices, hardware, software, operating systems, drivers, network interfaces and/or so forth. As illustrated, the configuration access control system 102 can comprise an obtaining component 110, determining component 112, generating component 114, verifying component 116, resolving component 118, executing component 120 and/or updating component 122. These components can be comprised by a processor 104 and/or one or more of these components can be external to the processor 104. A bus 105 can operatively couple the processor 104 and a memory 106.

Communication among the components of the configuration access control system 102 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE®and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 104, memory 106 and bus 105 of the configuration access control system 102.

In one or more embodiments, the configuration access control system 102 can comprise a processor 104 (e.g., computer processing unit, microprocessor, classical processor and/or like processor). In one or more embodiments, the processor 104 can be and/or be comprised by a controller.

In one or more embodiments, a component (which also can be referred to as a module) associated with configuration access control system 102, as described herein with or without reference to the one or more figures of the one or more embodiments, can comprise one or more computer and/or machine readable, writable and/or executable components and/or instructions that can be executed by processor 104 to facilitate performance of one or more processes defined by such component and/or instruction.

In one or more embodiments, the configuration access control system 102 can comprise a machine-readable memory 106 that can be operably connected to the processor 104. The memory 106 can store computer-executable instructions that, upon execution by the processor 104, can cause the processor 104 and/or one or more other components of the configuration access control system 102 to perform one or more actions. In one or more embodiments, the memory 106 can store computer-executable components.

The configuration access control system 102 and/or a component thereof as described herein, can be communicatively, electrically, operatively, optically and/or otherwise coupled to one another via a bus 105 to perform functions of non-limiting system architecture 100, configuration access control system 102 and/or one or more components thereof and/or coupled therewith. Bus 105 can comprise one or more of a memory bus, memory controller, peripheral bus, external bus, local bus and/or another type of bus that can employ one or more bus architectures. One or more of these examples of bus 105 can be employed to implement one or more embodiments described herein.

In one or more embodiments, configuration access control system 102 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the configuration access control system 102 can reside in the cloud, and/or can reside locally in a local computing environment (e.g., at a specified location).

In addition to the processor 104 and/or memory 106 described above, the configuration access control system 102 can comprise one or more computer and/or machine readable, writable and/or executable components and/or instructions that, when executed by processor 104, can facilitate performance of one or more operations defined by such component and/or instruction.

It is noted that in one or more embodiments, the obtaining component 110, determining component 112, generating component 114, verifying component 116, resolving component 118, executing component 120 and/or updating component 122 can be implemented independently, without one or more other of the obtaining component 110, determining component 112, generating component 114, verifying component 116, resolving component 118, executing component 120 and/or updating component 122. Additionally and/or alternatively, the obtaining component 110, determining component 112, generating component 114, verifying component 116, resolving component 118, executing component 120 and/or updating component 122 can be comprised by a high-level analyzing component 103, one or more of the below-described functions of the obtaining component 110, determining component 112, generating component 114, verifying component 116, resolving component 118, executing component 120 and/or updating component 122 can be performed by the high-level analyzing component 103, and/or the obtaining component 110, determining component 112, generating component 114, verifying component 116, resolving component 118, executing component 120 and/or updating component 122 can be omitted with the high-level analyzing component 103 performing one or more of the below-described functions of the one or more omitted obtaining component 110, determining component 112, generating component 114, verifying component 116, resolving component 118, executing component 120 and/or updating component 122.

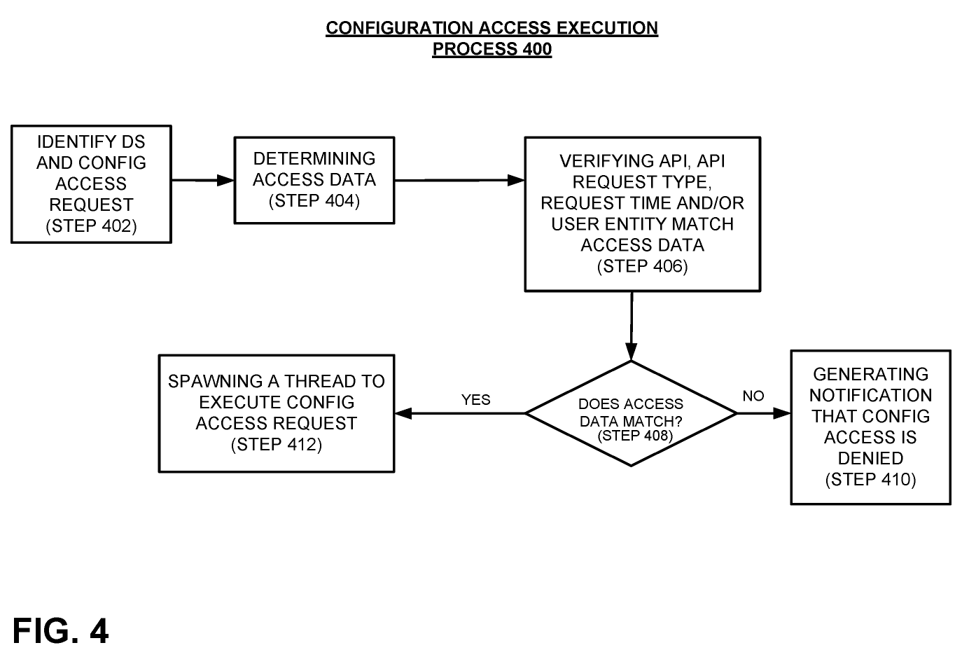

Direction next turns to an access data generation process 300, illustrated at FIG. 3, as well as still referring to FIGS. 1 and 2. The access data generation process 300 generally can be provided by the CAC system 102 to generate a schedule 190, for being stored at the information data store 240, or other location communicatively accessible to the CAC 102. Briefly, the schedule 190 can be employed by the CAC system 102 to execute the configuration access control process 400 illustrated at FIG. 4, and described later, below.

Looking to FIG. 3, one or more administrator entities 216 can use a computing device to access the information data store 240 and/or to access the CAC system 102. For example, the obtaining component 110 can obtain various aspects of input data 302, such as submitted by an administrator entity 216 to store at the information data store 240. This input data 302 can be employed by the determining component 112 and generating component 114 to generate the schedule 190.

It is noted that any suitable method of storage can be employed at the information data store 240. Data stored can be in any suitable format and can comprise data and/or metadata. In one or more embodiments, two or more information data stores 240 can be employed to store input data 302 for use by the CAC system 102.

The input data 302 provided by an administrator entity 216 and/or already present at the information data store 240. Can comprise specified time window data 242D, user entity data 204D, API data 215D, API request type data 217 and/or provision authority data 219, without being limited thereto.

Specified time window data 242D can comprise data defining one or more specified time windows 242, based on any suitable unit of time. For example, a specified time window 242 can define a time of day, hours of a day, days of a week, time range of a day or week, specific days of a month and/or any other custom measure of time, such as a second Thursday of each month. Units of such time can be in minutes, hours, and any suitable time scale, whether standard time and/or military time.

User entity data 240D can comprise data defining and/or specifying identities of user entities 215.

API data 215D can comprise data defining and/or specifying identities of particular APIs 215 and/or classifications of types of APIs 215.

API request type data 217 can comprise specifications defining PUT, POST, DELETE, GET and/or other request types that can be particularly requested to be performed by an API 215. In one or more embodiments, no particular API request type 217 can be requested. However, this data can be available to further narrow a CAC restriction provided by a CAC entry 320.

Provision authority data 219 can comprise data defining and/or specifying identities of administrator entities 216. Associated with such identities can be data corresponding to what types of, groups of, and/or any other classification of input data 302 can be modified, added, deleted and/or otherwise addressed by a particular administrator entity 216. For example, first provision access authority data 219 can specify that a first administrator entity 216 can modify specified time window data 242D but cannot modify any user entity data 204D. For another example, super provision access authority data 219 can specify that a super administrator entity 216 can have any access to any input data 302. Further, such super provision access authority data 219 can specify that such super access can override any other access and/or any other actions performed relative to the input data 302 by any other administrator entity 216 and/or by any administrator entity 216 having associated therewith a lower authority level than is associated with the administrator entity 216.

In one or more embodiments the input data 302 can comprise data defining a compliance requirement 170 to be satisfied by one or more CAC entries 320 of the schedule 190. For example, a compliance requirement 170 can require that a particular configuration access always be available and never be limited and/or denied. In one or more other embodiments, a compliance requirement 170 can require that a particular configuration access always be denied unless performed by a super administrator entity 216, for example. Such particular configuration accesses can comprise, but are not limited to, access to financial transaction configurations, for example, such as where an NAS 201 is employed by a financial institution, where the compliance requirement 170 is determined by regulation, rule, law and/or the like.

Relative to the access data generation process 300, the obtaining component 110 can obtain a request to enter input data 302 to an information data store 240, where the obtaining can comprise accessing, identifying, finding, receiving, searching, requesting and/or otherwise generally obtaining. Upon obtaining the request, the verifying component 116 can cross reference any request data comprised by and/or corresponding to the request against the provision authority data 219.

In one or more embodiments, only a super administrator entity 216, e.g., having a higher authority level associated therewith than a default administrator entity 216, can request write and/or modification actions relative to such provision authority data 219.

Next, a generation of the schedule 190, e.g., by the generating component 114, can be triggered on demand and/or at any specified frequency, such as where the schedule 190 is repeatedly generated and/or modified (e.g., updated) to allow for inclusion of revised, new and/or deleted input data 302 into the schedule 190 as one or more CAC parameters 310.

Upon determining of the triggering by the generating component 114 and/or by the determining component 112, the determining component 112 can determine at least a specified time window 242 relative to an application programming interface (API) 215 employed for configuration access to the control path 218 of the NAS 201.

In one or more embodiments, the determining component 112 can determine any combination of one or more types of the input data 302, comprising any plural aspects of any one or more same types of input data 302. This determining can be guided by a predefined schedule 190 format and/or specified by an administrator entity 216. In one or more embodiments, sets of input data 302, e.g., where a set specifies input data 302 for a CAC entry 320, can be predetermined, such as having been submitted by an administrator entity 216.

Based on the determining of the input data 302 by the determining component 112, the generating component 114 can generate a schedule 190 for the configuration access to the control path. In one or more embodiments, a CAC entry 320 of the schedule 190 can comprise an access-based time window 192 defining allowable access by an API 215 to the control path 218.

Regarding the schedule 190, any one or more CAC entries 320 can align to a same combination of CAC parameters. For example a first CAC entry 320 for the CAC parameters 310 can correspond to one time of access, while a second CAC entry 320 for the same CAC parameters 310 can correspond to a different time of access. Any one CAC entry 320 can provide for plural restrictions based on the same CAC parameters 310, such different restrictions for different days of the week of access, for example.

In one or more embodiments, the updating component 122 can update the input data 302 and/or the present schedule 190 based on a successful determination of execution of an update to a table 180 of the information data store 240, where the updating can comprise accessing log data having been written based on completion of the update to the table 180.

Accordingly, in summary, the generating component 114 can generate a schedule 190 comprising a plurality of CAC entries 320 each based on a set of one or more CAC parameters 310. The generating component 114 can store and/or direct storing of the schedule 190 at the information data store 240 and/or any other suitable storage location communicatively accessible by the CAC system 102.

Turning next to FIG. 4, and also still to FIGS. 1 and 2, a configuration access execution process 400 is illustrated. The configuration access execution process 400 generally can be provided by the CAC system 102 to determine whether access to the control path 218 should be allowed based on the schedule 190. That is, the schedule 190 can be employed by the CAC system 102, e.g., as a guide, to execute the configuration access control process 400 illustrated at FIG. 4.

For example, at step 402, the obtaining component 110 can access, identify, find, receive, search, request and/or otherwise generally obtain a configuration access request 140. The configuration access request 140 can comprise data and/or metadata in any suitable format. The configuration access request 140 can request access by a particular API 215 and/or by a particular user entity 214.

At step 404, the determining component 112 can determine that a CAC entry 320 associated with an API 215 and/or user entity 214, as obtained by the obtaining component 110, exists in the data store 240 (e.g., whether such CAC entry 320 is provided at a schedule 190 corresponding to the NAS 201).

At step 406 verifying component 116 can provide a verification that the obtained data of the configuration access request 140 matches the CAC parameters 310 of one or more CAC entries 320 determined by the determining component 112, by comparing the CAC parameters 310 to the obtained data of the configuration access request 140.

In one or more embodiments, the resolving component 118 can resolve an instance of conflict between a pair of access-based time restrictions of different determined CAC entries 320. For example, in one or more embodiments, the resolving component 118 can resolve an instance of conflict between a pair of access-based time restrictions associated with a same user entity 214 and API 215 combination, by employing one access-based time restriction, of the pair of access-based time restrictions, having a most recent date of entry to the data store. In one or more additional and/or alternative embodiments, the resolving component 118 can resolve an instance of conflict between a pair of access-based time restrictions associated with a same user entity 214 and API 215 combination, by employing one access-based time restriction, of the pair of access-based time restrictions, having data defining a greater administrator entity security level associated therewith.

This verifying can comprise determining, at step 408, by the executing component 120, whether a timing of the access that is being requested is within the access-based time window 192 determined by the determining component 112 and as verified by the verifying component 116. In one or more embodiments, relative to a step 412, in response to the timing of the access being determined to be within the access-based time restriction comprised by the determined entry 320, the executing component 120 can spawn a thread 198 to execute the configuration access request 140. In one or more other embodiments, relative to a step 410, in response to the timing of the access being determined not to be within the access-based time restriction comprised by the determined entry 320, the executing component 120 can generate a notification 196 that the configuration access request 140 is denied. The notification 196 can comprise data defining a reason for the access being denied, such as indicating that any one or more CAC parameters 310 have not been met.

### EXAMPLE OPERATIONS

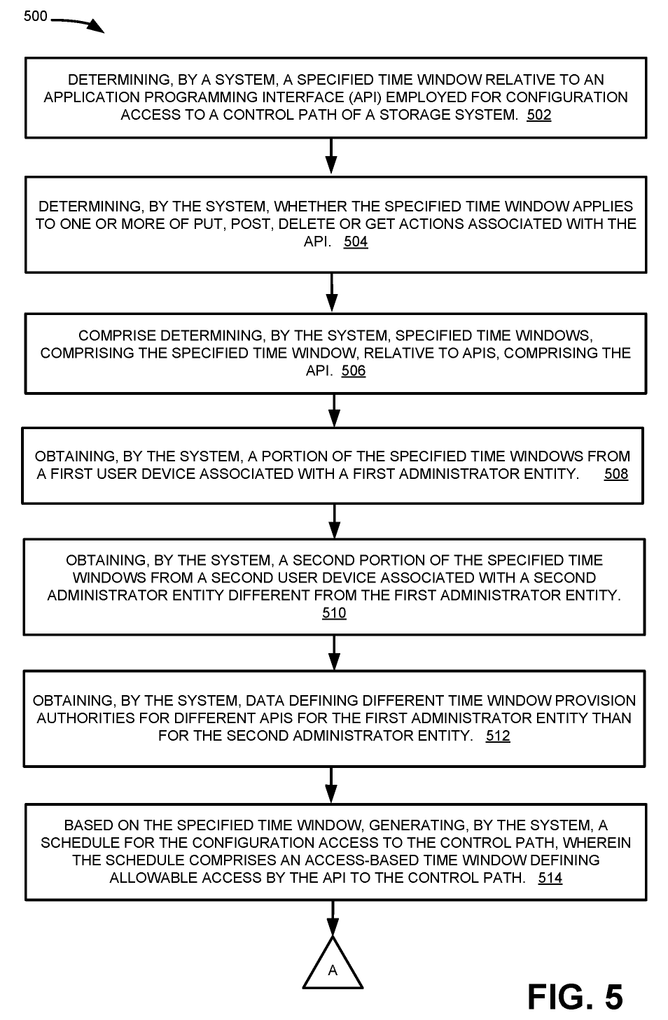

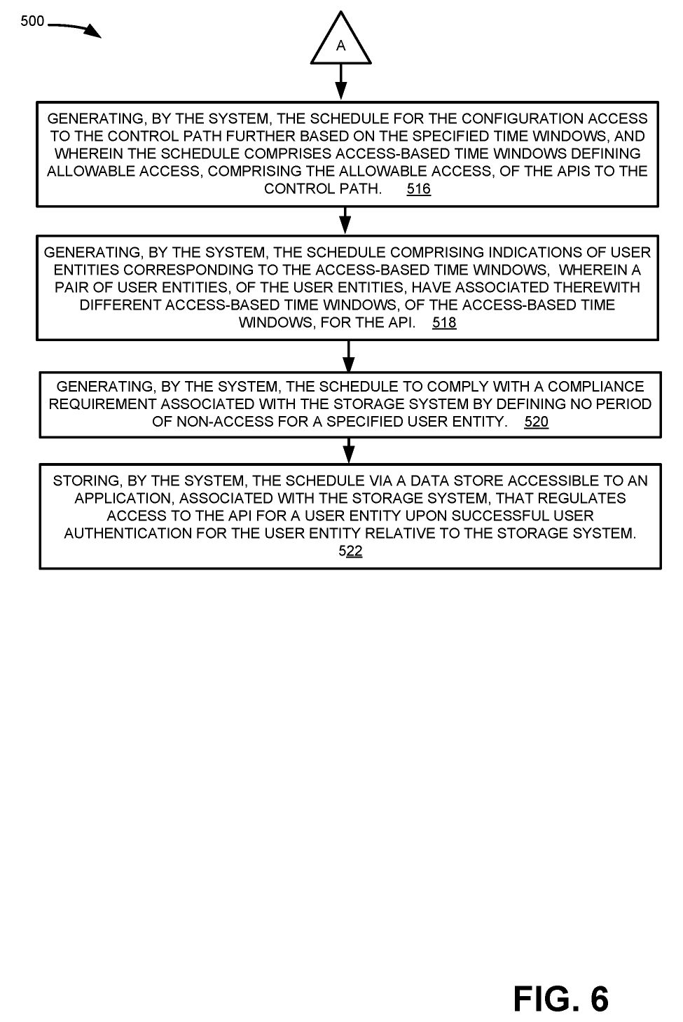

As a first summary of the above description relative to FIGS. 1-4, turning now to FIGS. 5 and 6, a process flow comprising a set of operations corresponding to at least generation of a configuration access control schedule 190 is set forth. One or more elements, objects and/or components referenced in the process flow 500 can be those of schematics 100-400. Repetitive description of like elements and/or processes employed in previously described embodiments is omitted for sake of brevity.

At operation 502, the process flow 500 can comprise determining, by a system (e.g., determining component 112), a specified time window (e.g., specified time window 242) relative to an application programming interface (API) (e.g., API 215) employed for configuration access to a control path (e.g., control path 218) of a storage system (e.g., NAS 201).

At operation 504, the process flow 500 can comprise determining, by the system (e.g., determining component 112), whether the specified time window applies to one or more of PUT, POST, DELETE or GET actions (e.g., API request types 217) associated with the API.

At operation 506, the process flow 500 can comprise determining, by the system (e.g., determining component 112), specified time windows, comprising the specified time window, relative to APIs, comprising the API.

At operation 508, the process flow 500 can comprise obtaining, by the system (e.g., obtaining component 110), a portion of the specified time windows from a first user device associated with a first administrator entity (e.g., administrator entity 216).

At operation 510, the process flow 500 can comprise obtaining, by the system (e.g., obtaining component 110), a second portion of the specified time windows from a second user device associated with a second administrator entity different from the first administrator entity.

At operation 512, the process flow 500 can comprise obtaining, by the system (e.g., obtaining component 110), data defining different time window provision authorities (e.g., provision authority data 219) for different APIs for the first administrator entity than for the second administrator entity.

At operation 514, the process flow 500 can comprise, based on the specified time window, generating, by the system (e.g., generating component 114), a schedule (e.g., schedule 190) for the configuration access to the control path, wherein the schedule comprises an access-based time window (e.g., access-based time window 192) defining allowable access by the API to the control path.

At operation 516, the process flow 500 can comprise generating, by the system (e.g., generating component 114), the schedule for the configuration access to the control path further based on the specified time windows, and wherein the schedule comprises access-based time windows defining allowable access, comprising the allowable access, of the APIs to the control path.

At operation 518, the process flow 500 can comprise, generating, by the system (e.g., generating component 114), the schedule comprising indications of user entities (e.g., user entities 214) corresponding to the access-based time windows, wherein a pair of user entities, of the user entities, have associated therewith different access-based time windows, of the access-based time windows, for the API.

At operation 520, the process flow 500 can comprise generating, by the system (e.g., generating component 114), the schedule to comply with a compliance requirement (e.g., compliance requirement 170) associated with the storage system by defining no period of non-access for a specified user entity.

At operation 522, the process flow 500 can comprise storing, by the system (e.g., generating component 114), the schedule via a data store (e.g., information datastore 240) accessible to an application, associated with the storage system, that regulates access to the API for a user entity upon successful user authentication for the user entity relative to the storage system.

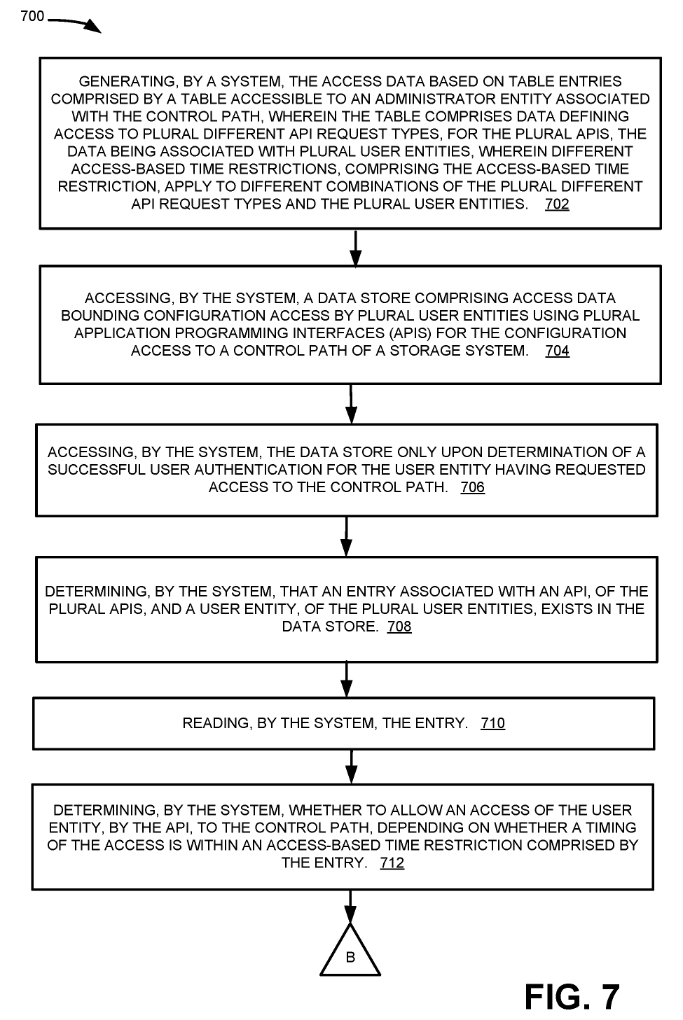

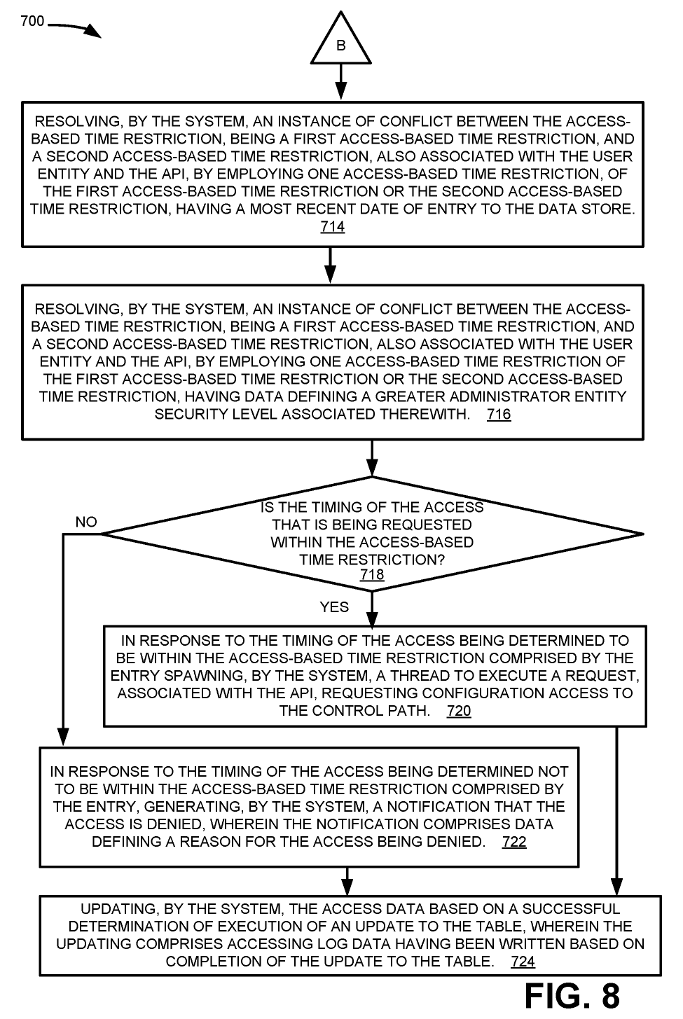

As a second summary of the above description relative to FIGS. 1-4, turning now to FIGS. 7 to 8, a process flow comprising a set of operations for use of a CAC schedule 190 to control access to a control path 218 for an NAS 201 is set forth. One or more elements, objects and/or components referenced in the process flow 700 can be those of schematics 100-400. Repetitive description of like elements and/or processes employed in previously described embodiments is omitted for sake of brevity.

At operation 702, the process flow 700 can comprise generating, by a system (e.g., generating component 114), the access data based on table entries comprised by a table (e.g., table 180) accessible to an administrator entity (e.g., administrator entity 216) associated with the control path (e.g., control path 218), wherein the table comprises data defining access to plural different API request types (e.g., API request types 217), for the plural APIs (e.g., APIs 215), the data being associated with plural user entities (e.g., user entities 214), wherein different access-based time restrictions, comprising the access-based time restriction, apply to different combinations of the plural different API request types and the plural user entities.

At operation 704, the process flow 700 can comprise accessing, by the system (e.g., obtaining component 110), a data store comprising access data bounding configuration access by plural user entities using plural application programming interfaces (APIs) for the configuration access to a control path of a storage system (e.g., NAS 201).

At operation 706, the process flow 700 can comprise accessing, by the system (e.g., obtaining component 110), the data store (e.g., information data store 240) only upon determination of a successful user authentication for the user entity having requested access to the control path.

At operation 708, the process flow 700 can comprise determining, by the system (e.g., determining component 112), that an entry associated with an API, of the plural APIs, and a user entity, of the plural user entities, exists in the data store.

At operation 710, the process flow 700 can comprise reading, by the system (e.g., determining component 112), the entry.

At operation 712, the process flow 700 can comprise determining, by the system (e.g., determining component 112), whether to allow an access of the user entity, by the API, to the control path, depending on whether a timing of the access is within an access-based time restriction comprised by the entry.

At operation 714, the process flow 700 can comprise resolving, by the system (e.g., resolving component 118), an instance of conflict between the access-based time restriction, being a first access-based time restriction, and a second access-based time restriction, also associated with the user entity and the API, by employing one access-based time restriction, of the first access-based time restriction or the second access-based time restriction, having a most recent date of entry to the data store.

At operation 716, the process flow 700 can comprise resolving, by the system (e.g., resolving component 118), an instance of conflict between the access-based time restriction, being a first access-based time restriction, and a second access-based time restriction, also associated with the user entity and the API, by employing one access-based time restriction of the first access-based time restriction or the second access-based time restriction, having data defining a greater administrator entity security level associated therewith.

At operation 718, the process flow 700 can comprise, determining, by the system (e.g., executing component 120), if the timing of the access that is being requested is within the access-based time restriction. If yes, the process flow can proceed to step 720. If not, the process flow can proceed instead to step 722. Both steps 720 and 722 subsequently proceed to step 724.

At operation 720, the process flow 700 can comprise, in response to the timing of the access being determined to be within the access-based time restriction comprised by the entry spawning, by the system (e.g., executing component 120), a thread (e.g., thread 198) to execute a request (e.g., configuration access request 140), associated with the API, requesting configuration access to the control path.

At operation 722, the process flow 700 can comprise, in response to the timing of the access being determined not to be within the access-based time restriction comprised by the entry, generating, by the system (e.g., executing component 120), a notification (e.g., notification 196) that the access is denied, wherein the notification comprises data defining a reason for the access being denied.

At operation 724, the process flow 700 can comprise updating, by the system (e.g., updating component 122), the access data based on a successful determination of execution of an update to the table, wherein the updating comprises accessing log data (e.g., log data 182) having been written based on completion of the update to the table.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the figures provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described is technology that facilitates control of configuration access to a control path of a network access storage system. An example system comprises at least one processor, and at least one memory that stores executable instructions that, when executed by the at least one processor, facilitate performance of operations, comprising determining a specified time window relative to an application programming interface (API) employed for configuration access to a control path of a storage system, and based on the specified time window, generating a schedule for the configuration access to the control path, wherein the schedule comprises an access-based time window defining allowable access by the API to the control path.

An example benefit of one or more of the above-indicated method, system and/or non-transitory computer-readable medium can be an ability to provide a level of configuration access control that cannot be provided by existing frameworks. This configuration access control can comprise use of plural access-based time windows for a same API or user entity requesting configuration access, use of different access-based time windows for different APIs, user entities and/or combinations thereof, and/or use of different access-based time windows for different request types being sought relative to an API and/or user entity.

Further, this control of privileges of access to an NAS control path, relative to APIs and/or user entities, can be provided in scale. For example, configuration access to plural, even hundreds or more machines in a cluster of an NAS can be controlled using the one or more embodiments described herein. Such control can be provided for one or more control paths corresponding to plural NASs and/or plural clusters (of a same or different NASs) at least partially at a same time as one another. In one or more embodiments, generation of a control schedule 190 can be provided at least partially at a same time as use of the control schedule 190. In one or more embodiments, generation of plural control schedules 190 can be provided at least partially at a same time as one another. In one or more embodiments, use of plural control schedules 190 can be provided at least partially at a same time as one another.

Another example benefit of one or more of the above-indicated method, system and/or non-transitory computer-readable medium can be an ability to provide supervisory control of the configuration access control. That is, provision access (e.g., access related to provision of parameters, guidelines, metes and/or bounds for defining one or more configuration access controls) can be controlled by the one or more frameworks described herein. This provision access can be self-resolving, such as in instances of overlapping and/or conflicting configuration access control entries. In one or more cases, resolution can be a function of authentication level (e.g., administrator entity security level) corresponding to a configuration access control restriction (or related configuration access parameter on which the configuration access control restriction is based). Additionally, and/or alternatively, in one or more cases, resolution can be a function of a time of entry of the configuration access control restriction (or related configuration access parameter on which the configuration access control restriction is based).

Still another example benefit of one or more of the above-indicated method, system and/or non-transitory computer-readable medium can be an ability to provide one or more of the above-noted benefits across varying types of network access storage systems (NASs) and/or corresponding control paths, thus allowing for the one or more embodiments described herein to be hardware, software and/or vendor agnostic relative to different NASs and/or control paths. In this way, a configuration access system described herein can be employed to control user entity access to an NAS control path, generally absent being dependent on a single product, service, device, vendor and/or platform of NASs and/or control paths being controlled and/or secured. In this way, it can be easier for an NAS service provider (NSP) to meet desired scale and/or deployment consistency requirements.

Indeed, in view of the one or more embodiments described herein, a practical application of the above-indicated method, system and/or non-transitory computer-readable medium can be an ability to provide varying degrees of access control to a control path of an NAS, beyond mere discrete access restrictions, such as access allowed at all times, no access allowed at any time, and/or other extreme restrictions that are the only options available to existing frameworks. That is, the one or more embodiments described herein are not limited to a discrete set of access-based time restrictions. Instead, varying degrees of granularity of control can be employed, as described herein. As a result, different access-based time restrictions can be employed for different APIs, user entities, data of an NAS, etc. without limiting to a one-size-fits-all access-based time restriction. In one or more cases, the dynamic control provided by the one or more embodiments described herein can allow for satisfying of varying control and/or compliance requirements, rules and/or regulations.

These are useful and practical applications of computers, thus providing enhanced (e.g., improved and/or optimized) security for a control path of one or more network access storage systems. In one or more embodiments, a framework described herein can provide for automatic generation of a schedule for bounding configuration access control to a control path. The generation can be based on access data provided at one or more data stores. In one or more embodiments, a framework described herein can be self-determining relative to whether or not to allow access of a user entity/API to the control path. For example, the one or more frameworks described herein can self-resolve conflicts and/or overlap of two or more access-based time restrictions based on security level, authority level and/or time of entry related to an access-based time restriction and/or configuration access control (CAC) parameter underlying such restriction. Overall, such tools can constitute a concrete and tangible technical and/or physical improvement in the fields of network access storage systems and corresponding control paths.

Furthermore, one or more embodiments described herein can be employed in a real-world system based on the disclosed teachings. For example, one or more embodiments described herein can function with a computer system and/or one or more servers for internet, cloud and/or internal/external networks to perform the aforementioned configuration access generation and/or execution processes.

Further, one or more embodiments described herein are inherently and/or inextricably tied to computer technology and cannot be implemented outside of a computing environment. For example, one or more processes performed by one or more embodiments described herein can more efficiently, and even more feasibly, provide computer-aided control of access to a control path of an NAS, as compared to existing systems and/or techniques. Systems, computer-implemented methods and/or computer program products facilitating performance of these processes are of great utility in the fields of network access storage systems and corresponding control paths and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively access computer-stored data, access an NAS control path, generate computer data, and/or communicate with a computer-based interface at a digital level of computerized communication, as the one or more embodiments described herein can facilitate these processes. For example, a human, or even thousands of humans, cannot efficiently, accurately and/or effectively determine diverse access restrictions corresponding to millions or even billions of files of a network access storage system, let along provide such determining at a speed facilitating efficient configuration access to an NAS control path. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

The paragraphs that follow provide additional summary reciting a system, a method and a computer-readable medium.

A system, comprising: at least one processor; and at least one memory that stores executable instructions that, when executed by the at least one processor, facilitate performance of operations, comprising: determining a specified time window relative to an application programming interface (API) employed for configuration access to a control path of a storage system; and based on the specified time window, generating a schedule for the configuration access to the control path, wherein the schedule comprises an access-based time window defining allowable access by the API to the control path.

The system of the preceding paragraph, wherein the operations further comprise: generating the schedule to comprise both the access-based time window and a user entity corresponding to the access-based time window.

The system of any preceding paragraph, wherein the operations further comprise: determining specified time windows, comprising the specified time window, relative to APIs, comprising the API, wherein the generating of the schedule comprises generating the schedule for the configuration access to the control path further based on the specified time windows, and wherein the schedule comprises access-based time windows defining allowable access, comprising the allowable access, of the APIs to the control path.

The system of any preceding paragraph, wherein the schedule further comprises indications of user entities corresponding to the access-based time windows, and wherein a pair of user entities, of the user entities, have associated therewith different access-based time windows, of the access-based time windows, for the API.

The system of any preceding paragraph, wherein the operations further comprise: obtaining a portion of the specified time windows from a first user device associated with a first administrator entity; obtaining a second portion of the specified time windows from a second user device associated with a second administrator entity different from the first administrator entity; and obtaining data defining different time window provision authorities for different APIs for the first administrator entity than for the second administrator entity.

The system of any preceding paragraph, wherein the access-based time window complies with a compliance requirement associated with the storage system by defining no period of non-access for a specified user entity.

The system of any preceding paragraph, wherein the operations further comprise: determining whether the specified time window applies to one or more of PUT, POST, DELETE or GET actions associated with the API.

The system of any preceding paragraph, wherein the operations further comprise: storing the schedule via a data store accessible to an application, associated with the storage system, that regulates access to the API for a user entity upon successful user authentication for the user entity relative to the storage system.

A method, comprising: accessing, by a system comprising at least one processor, a data store comprising access data bounding configuration access by plural user entities using plural application programming interfaces (APIs) for the configuration access to a control path of a storage system; determining that an entry associated with an API, of the plural APIs, and a user entity, of the plural user entities, exists in the data store; reading the entry; and determining whether to allow an access of the user entity, by the API, to the control path, depending on whether a timing of the access is within an access-based time restriction comprised by the entry.

The method of the preceding paragraph, wherein the accessing of the data store is executed upon determination of a successful user authentication for the user entity having requested access to the control path.

The method of any preceding paragraph, further comprising: resolving an instance of conflict between the access-based time restriction, being a first access-based time restriction, and a second access-based time restriction, also associated with the user entity and the API, by employing one access-based time restriction, of the first access-based time restriction or the second access-based time restriction, having a most recent date of entry to the data store.

The method of any preceding paragraph, further comprising: resolving an instance of conflict between the access-based time restriction, being a first access-based time restriction, and a second access-based time restriction, also associated with the user entity and the API, by employing one access-based time restriction of the first access-based time restriction or the second access-based time restriction, having data defining a greater administrator entity security level associated therewith.

The method of any preceding paragraph, further comprising: in response to the timing of the access being determined to be within the access-based time restriction comprised by the entry, spawning a thread to execute a request, associated with the API, requesting configuration access to the control path.

The method of any preceding paragraph, further comprising: in response to the timing of the access being determined not to be within the access-based time restriction comprised by the entry, generating a notification that the access is denied, wherein the notification comprises data defining a reason for the access being denied.

The method of any preceding paragraph, wherein the generating comprises: generating the access data based on table entries comprised by a table accessible to an administrator entity associated with the control path, wherein the table comprises data defining access to plural different API request types, for the plural APIs, the data being associated with plural user entities, wherein different access-based time restrictions, comprising the access-based time restriction, apply to different combinations of the plural different API request types and the plural user entities.

The method of any preceding paragraph, wherein the generating comprises: updating the access data based on a successful determination of execution of an update to the table, wherein the updating comprises accessing log data having been written based on completion of the update to the table.

A non-transitory machine-readable medium, comprising executable instructions that, when executed by at least one processor facilitate performance of operations, comprising: identifying a database comprising access data bounding configuration access by application programming interfaces (APIs) to a control path of a storage system; enabling a full access to a full amount of the access data to fewer than all administrator entities having access to the database; enabling updating of only a portion of the access data by an administrator entity of the administrator entities; and allowing access to the control path by a user entity controlling an API to the control path based on the portion of the access data, wherein the portion of the access data comprises an access-based time restriction that is a function of a combination of the user entity and the API.

The non-transitory machine-readable medium of the preceding paragraph, wherein the access-based time restriction corresponds specifically to a specified one or more of PUT, POST, DELETE or GET actions requested to be performed by the API at the storage system.

The non-transitory machine-readable medium of any preceding paragraph, wherein the access-based time restriction is further the function of a specified one or more days of a week.

The non-transitory machine-readable medium of any preceding paragraph, wherein the operations further comprise: enabling updating of any of the access data by a super administrator entity of the administrator entities; and overriding an update by the administrator entity based on an update request received from the super administrator entity.

### EXAMPLE OPERATING ENVIRONMENT

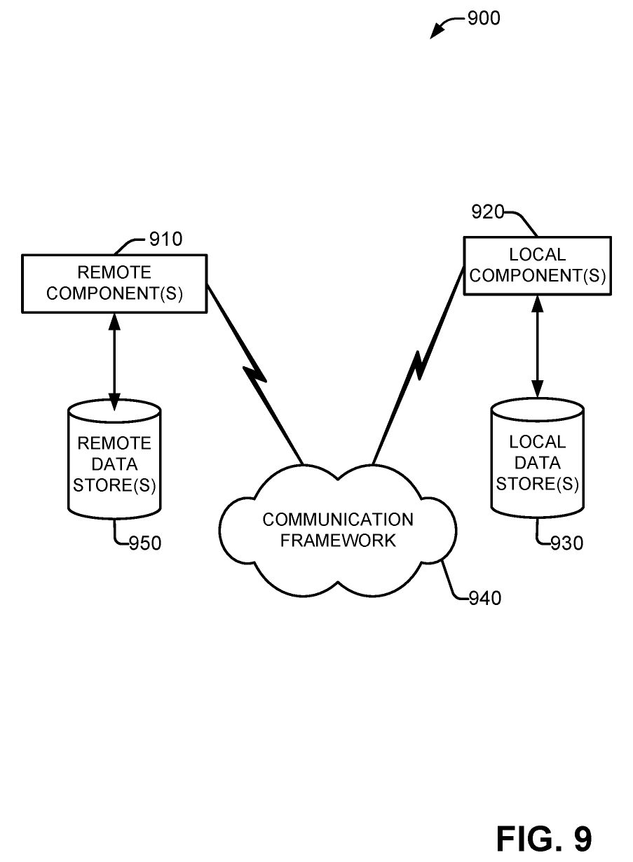

FIG. 9 is a schematic block diagram of an operating environment 900 with which the described subject matter can interact. The operating environment 900 comprises one or more remote component(s) 910. The remote component(s) 910 can be hardware and/or software (e.g., threads, processes, computing devices). In one or more embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The operating environment 900 also comprises one or more local component(s) 920. The local component(s) 920 can be hardware and/or software (e.g., threads, processes, computing devices). In one or more embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The operating environment 900 comprises a communication framework 940 that can be employed to facilitate communications between the remote component(s) 910 and the local component(s) 920, and can comprise an air interface, e.g., interface of a UMTS network, via an LTE network, etc. Remote component(s) 910 can be operably connected to one or more remote data store(s) 950, such as a hard drive, solid state drive, subscriber identity module (SIM) card, electronic SIM (eSIM), device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### EXAMPLE COMPUTING ENVIRONMENT

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in computing environment 1000, a solid-state drive (SSD) could be used in addition to, or in place of, an HDD 1014.

Other internal or external storage can include at least one other storage device 1020 with storage media 1022 (e.g., a solid-state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer 1050. The remote computer 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
at least one processor; and
at least one memory that stores executable instructions that, when executed by the at least one processor, facilitate performance of operations, comprising:
determining a specified time window relative to an application programming interface (API) employed for configuration access to a control path of a storage system; and
based on the specified time window, generating a schedule for the configuration access to the control path,
wherein the schedule comprises an access-based time window defining allowable access by the API to the control path.

2. The system of claim 1, wherein the operations further comprise:
generating the schedule to comprise both the access-based time window and a user entity corresponding to the access-based time window.

3. The system of claim 1, wherein the operations further comprise:
determining specified time windows, comprising the specified time window, relative to APIs, comprising the API,
wherein the generating of the schedule comprises generating the schedule for the configuration access to the control path further based on the specified time windows, and
wherein the schedule comprises access-based time windows defining allowable access, comprising the allowable access, of the APIs to the control path.

4. The system of claim 3, wherein the schedule further comprises indications of user entities corresponding to the access-based time windows, and
wherein a pair of user entities, of the user entities, have associated therewith different access-based time windows, of the access-based time windows, for the API.

5. The system of claim 3, wherein the operations further comprise:
obtaining a portion of the specified time windows from a first user device associated with a first administrator entity;
obtaining a second portion of the specified time windows from a second user device associated with a second administrator entity different from the first administrator entity; and
obtaining data defining different time window provision authorities for different APIs for the first administrator entity than for the second administrator entity.

6. The system of claim 1, wherein the access-based time window complies with a compliance requirement associated with the storage system by defining no period of non-access for a specified user entity.

7. The system of claim 1, wherein the operations further comprise:
determining whether the specified time window applies to one or more of PUT, POST, DELETE or GET actions associated with the API.

8. The system of claim 1, wherein the operations further comprise:
storing the schedule via a data store accessible to an application, associated with the storage system, that regulates access to the API for a user entity upon successful user authentication for the user entity relative to the storage system.

9. A method, comprising:
accessing, by a system comprising at least one processor, a data store comprising access data bounding configuration access by plural user entities using plural application programming interfaces (APIs) for the configuration access to a control path of a storage system;
determining that an entry associated with an API, of the plural APIs, and a user entity, of the plural user entities, exists in the data store;
reading the entry; and
determining whether to allow an access of the user entity, by the API, to the control path, depending on whether a timing of the access is within an access-based time restriction comprised by the entry.

10. The method of claim 9, wherein the accessing of the data store is executed upon determination of a successful user authentication for the user entity having requested access to the control path.

11. The method of claim 9, further comprising:
resolving an instance of conflict between the access-based time restriction, being a first access-based time restriction, and a second access-based time restriction, also associated with the user entity and the API, by employing one access-based time restriction, of the first access-based time restriction or the second access-based time restriction, having a most recent date of entry to the data store.

12. The method of claim 9, further comprising:
resolving an instance of conflict between the access-based time restriction, being a first access-based time restriction, and a second access-based time restriction, also associated with the user entity and the API, by employing one access-based time restriction of the first access-based time restriction or the second access-based time restriction, having data defining a greater administrator entity security level associated therewith.

13. The method of claim 9, further comprising:
in response to the timing of the access being determined to be within the access-based time restriction comprised by the entry, spawning a thread to execute a request, associated with the API, requesting configuration access to the control path.

14. The method of claim 9, further comprising:
in response to the timing of the access being determined not to be within the access-based time restriction comprised by the entry, generating a notification that the access is denied, wherein the notification comprises data defining a reason for the access being denied.

15. The method of claim 9, wherein the generating comprises:
generating the access data based on table entries comprised by a table accessible to an administrator entity associated with the control path, wherein the table comprises data defining access to plural different API request types, for the plural APIs, the data being associated with plural user entities, wherein different access-based time entries, comprising the access-based time restriction, apply to different combinations of the plural different API request types and the plural user entities.

16. The method of claim 15, wherein the generating comprises:
updating the access data based on a successful determination of execution of an update to the table,
wherein the updating comprises accessing log data having been written based on completion of the update to the table.

17. A non-transitory machine-readable medium, comprising executable instructions that, when executed by at least one processor facilitate performance of operations, comprising:
identifying a data store comprising access data bounding configuration access by application programming interfaces (APIs) to a control path of a storage system;
enabling a full access to a full amount of the access data to fewer than all administrator entities having access to the data store;
enabling updating of only a portion of the access data by an administrator entity of the administrator entities; and
allowing access to the control path by a user entity controlling an API to the control path based on the portion of the access data,
wherein the portion of the access data comprises an access-based time restriction that is a function of a combination of the user entity and the API.

18. The non-transitory machine-readable medium of claim 17, wherein the access-based time restriction corresponds specifically to a specified one or more of PUT, POST, DELETE or GET actions requested to be performed by the API at the storage system.

19. The non-transitory machine-readable medium of claim 17, wherein the access-based time restriction is further the function of a specified one or more days of a week.

20. The non-transitory machine-readable medium of claim 17, wherein the operations further comprise:
enabling updating of any of the access data by a super administrator entity of the administrator entities; and
overriding an update by the administrator entity based on an update request received from the super administrator entity.
